(19) United States
(12) Patent Application Publication
(10) Pub. No.: US 2026/0208710 A1
(43) Pub. Date: Jul. 23, 2026

(54) METHOD FOR OPERATING AN ELECTROMECHANICAL BRAKING SYSTEM AND VEHICLE HAVING AN ELECTROMECHANICAL BRAKING SYSTEM

(71) Applicant: Robert Bosch GmbH, Stuttgart (DE)

(72) Inventors: Herbert Vollert, Vaihingen/Enz (DE); Lisa Kurz, Heilbronn (DE); Steffen Benzler, Eberdingen (DE); Xun Yao, Beilstein (DE)

(21) Appl. No.: 19/438,768

(22) Filed: Jan. 2, 2026

(30) Foreign Application Priority Data
Jan. 17, 2025 (DE) 10 2025 101 702.6

(51) Int. Cl. B60T 8/1766; B60T 8/171; B60T 8/172; B60T 13/74

(52) U.S. Cl. CPC B60T 8/1766; B60T 8/171; B60T 8/172; B60T 13/741

(57) ABSTRACT

A method for operating an electromechanical braking system of a vehicle having an electromechanical front and rear axle brake mounted on a front and real axle, respectively, of the vehicle. The method includes: detecting a front axle brake temperature of the front axle brake and controlling the front axle brake and the rear axle brake in such a way that: up to a specified front axle brake temperature, a first maximum front axle braking force can be provided using the front axle brake and a first maximum rear axle braking force, which is less than the first maximum front axle braking force, can be provided using the rear axle brake, and above the specified front axle brake temperature, a second maximum front axle braking force can be provided using the front axle brake and a second maximum rear axle braking force can be provided using the rear axle brake.

### CROSS REFERENCE

The present application claims the benefit under 35 U.S.C. § 119of Germany Patent Application No. DE 10 2025 101 702.6 filed on Jan. 17, 2025, which is expressly incorporated herein by reference in its entirety.

### FIELD

The present invention relates to a method for operating an electromechanical braking system and to a vehicle having an electromechanical braking system.

### BACKGROUND INFORMATION

Braking systems in vehicles are often subjected to heavy loads, which are caused, for example, by repeated braking during downhill driving or in urban traffic and can lead to overheating. An overheated braking system can result in reduced braking power or damage to brake components. These problems occur with both conventional hydraulic braking systems and electromechanical braking systems, which make individual wheel braking possible and have gained importance in recent years.

### SUMMARY

An object of the present invention is to prevent damage to an electromechanical braking system in the event of overheating while simultaneously ensuring sufficient braking power.

This object may be achieved in a first aspect of the present invention by a method for operating an electromechanical braking system of a vehicle having at least one electromechanical front axle brake mounted on a front axle of the vehicle and at least one electromechanical rear axle brake mounted on a rear axle of the vehicle. According to an example embodiment of the present invention, wherein the method comprises:
detecting the front axle brake temperature of the at least one front axle brake and
controlling the at least one front axle brake and the at least one rear axle brake in such a way that:
   up to a specified front axle brake temperature, a first maximum front axle braking force can be provided by means of the at least one front axle brake, and a first maximum rear axle braking force, which is less than the first maximum front axle braking force, can be provided by means of the at least one rear axle brake, and
   after the specified front axle brake temperature is reached, a second maximum front axle braking force can be provided by means of the at least one front axle brake, and a second maximum rear axle braking force can be provided by means of the at least one rear axle brake,
wherein the second maximum front axle braking force is less than the first maximum front axle braking force and the second maximum rear axle braking force is greater than the first maximum rear axle braking force.

In the method according to the present invention, for reasons of driving stability, up to the specified front axle brake temperature, the first maximum front axle braking force that can be provided by means of the at least one front axle brake is greater than the first maximum rear axle braking force that can be provided by means of the at least one rear axle brake. Therefore, the at least one front axle brake is subjected to greater load than the at least one rear axle brake, so that up to the specified front axle brake temperature, the front axle brake temperature is higher than the rear axle brake temperature.

The front axle brake temperature and the rear axle brake temperature can be ascertained, for example, by means of appropriate temperature sensors. Alternatively or additionally, the front axle brake temperature and the rear axle brake temperature can be ascertained by means of model-based monitoring, in which a brake temperature is ascertained on the basis of its load in a certain time interval.

In order to be able to prevent damage to the at least one front axle brake due to excessive heating, the braking force is redistributed between the at least one front axle brake and the at least one rear axle brake when the specified front axle brake temperature is reached, by reducing the maximum braking force that can be provided by means of the at least one front axle brake to the second maximum front axle braking force and increasing the maximum rear axle braking force that can be provided by means of the at least one rear axle brake to the second maximum rear axle braking force. This can prevent damage to the at least one front axle brake.

Here, “at least one front axle brake” refers to one or more brakes mounted on a front axle of a vehicle (front wheel brakes). These brakes can be mounted, for example, in association with the respective wheels on the front axle of the vehicle and can be configured to decelerate the respective wheels individually. Similarly, “at least one rear axle brake” refers to one or more brakes mounted on a rear axle of a vehicle (rear wheel brakes). These brakes can be mounted, for example, in association with the respective wheels on the rear axle of the vehicle and can be configured to decelerate the respective wheels individually.

The at least one electromechanical front axle brake and the at least one electromechanical rear axle brake can, for example, in each case comprise an electric motor and a rotary/translational transmission that is configured to convert a rotational movement of a shaft of the electric motor into a translational movement, in order to bring a brake pad of the corresponding brake into physical contact with a brake disk or to lift it away therefrom.

The at least one electromechanical front axle brake and the at least one electromechanical rear axle brake can, for example, be controlled via the power supply to the associated electric motor. As a result, a maximum braking force that can be provided by the respective brakes can also be changed.

In order to be able to ensure stable driving behavior of the vehicle even after the specified front axle brake temperature has been reached, it can also be provided that the second maximum front axle braking force is greater than the second maximum rear axle braking force.

According to an example embodiment of the present invention, if the braking system continues to be heavily loaded even after the specified front axle brake temperature has been reached, the rear axle brake temperature can also rise, which ultimately also carries the risk of damage to the at least one rear axle brake. In order to be able to prevent damage to the at least one rear axle brake, the method can further comprise: deactivating the at least one rear axle brake when a specified rear axle brake temperature is reached that is higher than the specified front axle brake temperature.

Furthermore, according to an example embodiment of the present invention, it can be provided that after the at least one rear axle brake has been deactivated, the second maximum front axle braking force can still be provided by means of the at least one front axle brake. In particular, this means that the at least one front axle brake will remain in operation, but will only provide limited braking power. The driver may be informed of the reduced braking power, so that the vehicle can be stopped to allow the braking system to cool down and therefore restore full braking power. After the braking system has cooled down, an ignition cycle can fully restore the braking power of both the front axle brakes and the rear axle brakes.

In summary, it can be stated that according to the method described in the present disclosure, the braking power at the rear axle is “sacrificed,” so that braking power at the front axle can be maintained for as long as possible, which is more important with regard to driving stability.

The preceding task is achieved in a second aspect of the present invention by a vehicle having an electromechanical braking system. According to an example embodiment of the present invention, the electromechanical braking system comprises:
at least one electromechanical front axle brake mounted on a front axle of the vehicle, and
at least one electromechanical rear axle brake mounted on a rear axle of the vehicle, along with
a control device that is configured to control the at least one front axle brake and the at least one rear axle brake, in such a way that:
   up to a specified front axle brake temperature, a first maximum front axle braking force can be provided by means of the at least one front axle brake, and a first maximum rear axle braking force, which is less than the first maximum front axle braking force, can be provided by means of the at least one rear axle brake, and
   after the specified front axle brake temperature is reached, a second maximum front axle braking force can be provided by means of the at least one front axle brake, and a second maximum rear axle braking force can be provided by means of the at least one rear axle brake,
wherein the second maximum front axle braking force is less than the first maximum front axle braking force and the second maximum rear axle braking force is greater than the first maximum rear axle braking force.

With a vehicle designed in this way, the technical effects achievable in connection with the method described at the beginning can be achieved.

With regard to stable driving behavior, the second maximum front axle braking force can also be greater than the second maximum rear axle braking force.

According to an example embodiment of the present invention, the control device can be configured to deactivate the at least one rear axle brake when a specified rear axle brake temperature is reached that is higher than the specified front axle brake temperature. Furthermore, it can be provided that after the at least one rear axle brake has been deactivated, the second maximum front axle braking force can still be provided by means of the at least one front axle brake.

The present invention is explained in more detail below with reference to the figures.

### BRIEF DESCRIPTION OF THE DRAWINGS

FIG. 1 is a schematic representation of a vehicle according to an example embodiment of the present invention.

FIG. 2 is a graphical representation that shows the temporal progression of the maximum front axle braking force and the maximum rear axle braking force in a method and vehicle according to an example embodiment of the present invention.

FIG. 3 is a graphical representation that shows the temporal progression of the at least one front axle brake temperature and the at least one rear axle brake temperature in a method and vehicle according to an example embodiment of the present invention.

FIG. 4 is a flowchart of an exemplary method according to an example embodiment of the present invention.

### DETAILED DESCRIPTION OF EXAMPLE EMBODIMENTS

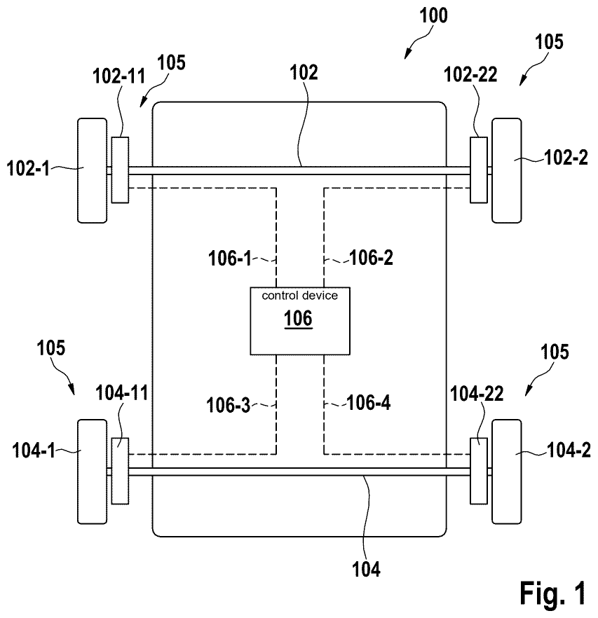

FIG. 1 is a schematic representation of a vehicle 100 according to the present disclosure. The vehicle 100 comprises a front axle 102 and a rear axle 104. On the front axle 102, a left front wheel 102-1 can be provided at a left end of the front axle 102, as well as a right front wheel 102-2 at a right end of the front axle 102. A left electromechanical front axle brake 102-11 can be provided on the left front wheel 102-1, which is configured to decelerate the left front wheel 102-1. A right electromechanical front axle brake 102-22 can be provided on the right front wheel 102-2, which is configured to decelerate the right front wheel 102-2.

On the rear axle 104, a left rear wheel 104-1 can be provided at a left end of the rear axle 104 and a right rear wheel 104-2 at a right end of the rear axle 104. A left electromechanical rear axle brake 104-11 can be provided on the left rear wheel 104-1, which is configured to decelerate the left rear wheel 104-1. A right electromechanical rear axle brake 104-22 can be provided on the right rear wheel 104-2, which is configured to decelerate the right rear wheel 104-2.

The relative terms used here, such as “left,” “right,” “front,” “rear” refer to the representation according to FIG. 1 and are not intended to limit the present disclosure. These terms can, for example, describe the directions from the perspective of a driver when the vehicle 100 is traveling straight ahead.

The front axle brakes 102-11, 102-22 and the rear axle brakes 104-11, 104-22 are components of an electromechanical braking system 105.

The vehicle 100 also comprises a control device 106 that is configured to individually control the left front axle brake 102-11, the right front axle brake 102-22, the left rear axle brake 104-11 and the right rear axle brake 104-22. The control device 106 is in data exchange communication with the respective brakes via respective signal lines 106-1, 106-2, 106-3, 106-4.

The front axle brakes 102-11, 102-22 and the rear axle brakes 104-11 and 104-22 can in each case comprise an electric motor and a rotary/translational transmission, which is configured to convert a rotary movement of a shaft of the electric motor into a translational movement of a particular brake pad, by which the respective brake pads can be brought into contact with the associated brake disks in order to achieve a braking effect, or can be moved away from the brake disks in order to prevent a braking effect.

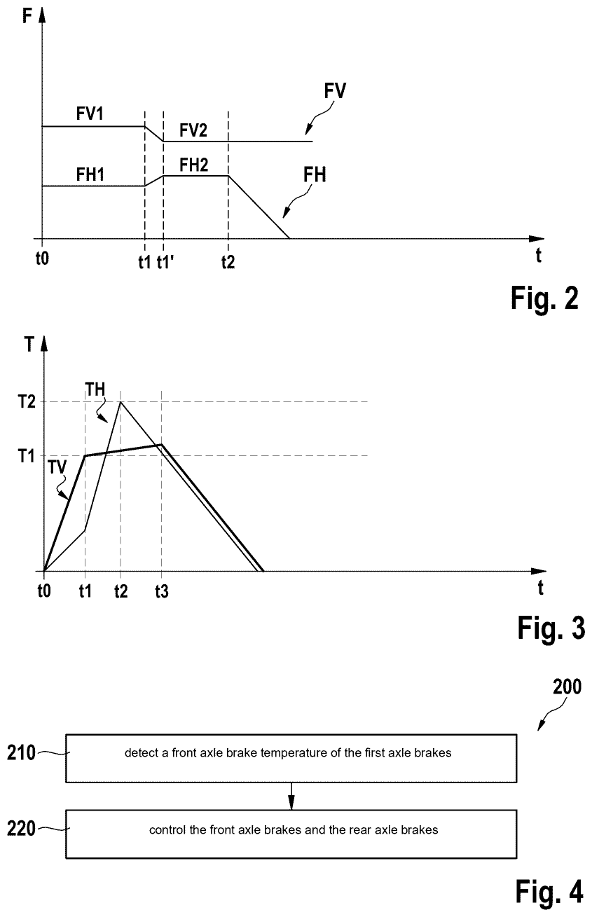

The control device 106 can be configured to adjust the maximum braking forces that can be provided on the front axle 102 and on the rear axle 104 according to the front axle brake temperature TV, i.e. a temperature at the front axle brakes 102-11 and 102-22, and the rear axle brake temperature TH, i.e. a temperature at the rear axle brakes 104-11 and 104-22. This is explained in more detail below with reference to FIGS. 2 and 3.

FIG. 2 is a schematic representation that shows the progression of a maximum front axle braking force FV, i.e. the maximum braking force that can be provided by means of the front axle brakes 102-11 and 102-22, and the progression of a maximum rear axle braking force FH, i.e. the maximum braking force that can be provided by means of the rear axle brakes 104-11 and 104-22, over time t.

FIG. 3 is a schematic representation that shows the progression of a front axle brake temperature TV, i.e. a temperature of the front axle brakes 102-11 and 102-22, and a progression of a rear axle brake temperature TH, i.e. a temperature of the rear axle brakes 104-11 and 104-22, over time t.

The front axle brakes 102-11, 102-22 and the rear axle brakes 104-11 and 104-22 are controlled by means of the control device 106 on the basis of the front axle brake temperature TV and the rear axle brake temperature TH. The front axle brake temperature TV and the rear axle brake temperature TH can be detected by means of temperature sensors that are associated with the respective brakes. Alternatively or additionally, the temperatures can be ascertained by means of a model that provides a brake temperature based on braking behavior over a past time interval.

The decisive factor is initially the front axle brake temperature TV, i.e. the temperature TV of the front axle brakes 102-11 and 102-22. If this temperature is below a specified front axle brake temperature T1, it can be assumed that the braking system 105 is not subjected to excessive stress. This state exists in FIGS. 2 and 3 during the time interval between the points in time t0 and t1.

During this time interval, a first maximum front axle braking force FV1 can be provided by means of the front axle brakes 102-11 and 102-22, and a first maximum rear axle braking force FH1 can be provided by means of the rear axle brakes 104-11 and 104-22. The first maximum front axle braking force FV1 is greater than the first maximum rear axle braking force FH1, which is desirable for reasons of driving stability.

As shown in FIG. 3, the front axle brake temperature TV reaches the first specified front axle brake temperature T1 at point in time t1, which indicates that the front axle brakes 102-11 and 102-22 are thermally overloaded. In order to prevent damage to the front axle brakes 102-11 and 102-22 due to this thermal overload, the control device 106 redistributes the maximum braking power between the front axle 102 and the rear axle 104 by reducing the maximum braking force FV that can be provided at the front axle 102 to a second maximum front axle braking force FV2 and increasing the maximum braking force FH that can be provided at the rear axle 104 to a second maximum rear axle braking force FH2. The change in the maximum braking force on the front axle 102 and the rear axle 104 is carried out in the period between points in time t1 and t1′. This area is not resolved in FIG. 3. The changeover of the maximum braking force is carried out at point in time t1 in FIG. 3.

As shown in FIG. 3, the redistribution of the maximum braking force by the control device 106 results in a decrease in the slope of the curve of the front axle brake temperature TV and an increase in that of the rear axle brake temperature TH. This relieves the front axle brakes 102-11 and 102-22 and thus keeps them functional for longer, which is desirable with regard to stable driving behavior. As shown in FIG. 2, even after point in time t1′, the second maximum front axle braking force FV2 that can be provided by the front axle brakes 102-11 and 102-22 can be greater than the second maximum rear axle braking force FH2 that can be provided by the rear axle brakes 104-11 and 104-22, which is advantageous for stable driving behavior.

If the braking system 105 is subjected to heavy loads even after point in time t1/t1′, the temperatures of the front axle brakes 102-11 and 102-22 continue to increase, but to a lesser extent. Compared to the front axle brakes 102-11 and 102-22, the load on the rear axle brakes 104-11 and 104-22 is greater from point in time t1/t1′, which can cause the rear axle brake temperature TH to exceed the front axle brake temperature TV, as shown by way of example in FIG. 3.

If the rear axle brake temperature TH reaches a specified rear axle brake temperature T2 that is higher than the specified front axle brake temperature T1, the control device 106 can deactivate the rear axle brakes 104-11 and 104-22 at point in time t2 in order to prevent damage to the rear axle brakes 104-11 and 104-22 due to overheating.

By deactivating the rear axle brakes 104-11 and 104-22, the rear axle brake temperature TH decreases from point in time t2, as shown in FIG. 3. As shown in FIG. 2, the rear axle braking force that can be provided by the rear axle brakes 104-11 and 104-22 also decreases accordingly from point in time t2. The driver of the vehicle 100 can be informed about the deactivation of the rear axle brakes 104-11 and 104-22, so that the driving behavior can be adjusted accordingly.

In order to be able to provide braking power even after the rear axle brakes 104-11 and 104-22 have been deactivated, it can be provided that the front axle brakes 102-11 and 102-22 are operated in such a way that they can continue to provide the second maximum front axle braking force FV2, so that the vehicle can still be braked safely until the braking system 105 is switched off and cools down.

For safety reasons, however, the vehicle 100 should be stopped after the rear axle brakes 104-11 and 104-22 have been deactivated, so that the braking system 105 can cool down and thus become functional again. As shown in FIG. 3, this is carried out at point in time t3, from which point the front axle brake temperature TV also decreases. After the braking system 205 has cooled down, the braking power can be fully restored by means of an ignition cycle.

FIG. 4 is a flowchart of an exemplary method 200 for operating the electromechanical braking system 105, wherein the method 200 comprises:
detecting 210 a front axle brake temperature TV of the front axle brakes 102-11, 102-22 and
controlling 220 the front axle brakes 102-11, 102-22 and the rear axle brakes 104-11, 104-22 in such a way that:
   up to a specified front axle brake temperature T1, a first maximum front axle braking force FV1 can be provided by means of the front axle brakes 102-11, 102-22, and a first maximum rear axle braking force FH1, which is less than the first maximum front axle braking force FV1, can be provided by means of the rear axle brakes 104-11, 104-22, and
   after the specified front axle brake temperature T1 is reached, a second maximum front axle braking force FV2 can be provided by means of the front axle brakes 102-11, 102-22, and a second maximum rear axle braking force FH2 can be provided by means of the rear axle brakes 104-11, 104-22,
wherein the second maximum front axle braking force FV2 is less than the first maximum front axle braking force FV1 and the second maximum rear axle braking force FH2 is greater than the first maximum rear axle braking force FH1.

What is claimed is:

1. A method for operating an electromechanical braking system of a vehicle, the electromechanical braking system including at least one electromechanical front axle brake mounted on a front axle of the vehicle, and at least one electromechanical rear axle brake mounted on a rear axle of the vehicle), wherein the method comprises the following steps:
detecting a front axle brake temperature of the at least one front axle brake; and
controlling the at least one front axle brake and the at least one rear axle brake in such a way that:
up to a specified front axle brake temperature, a first maximum front axle braking force can be provided using the at least one front axle brake and a first maximum rear axle braking force, which is less than the first maximum front axle braking force, can be provided using the at least one rear axle brake, and
after the specified front axle brake temperature is reached, a second maximum front axle braking force can be provided using the at least one front axle brake, and a second maximum rear axle braking force can be provided using the at least one rear axle brake,
wherein the second maximum front axle braking force is less than the first maximum front axle braking force and the second maximum rear axle braking force is greater than the first maximum rear axle braking force.

2. The method according to claim 1, wherein the second maximum front axle braking force is greater than the second maximum rear axle braking force.

3. The method according to claim 1, further comprising:
deactivating the at least one rear axle brake when a specified rear axle brake temperature is reached, which is higher than the specified front axle brake temperature.

4. The method according to claim 3, wherein after the at least one rear axle brake has been deactivated, the second maximum front axle braking force can still be provided using the at least one front axle brake.

5. A vehicle having an electromechanical braking system, the electromechanical braking system comprising:
at least one electromechanical front axle brake mounted on a front axle of the vehicle;
at least one electromechanical rear axle brake mounted on a rear axle of the vehicle; and
a control device that is configured to control the at least one front axle brake and the at least one rear axle brake in such a way that:
up to a specified front axle brake temperature: (i) a first maximum front axle braking force can be provided using the at least one front axle brake, and (ii) a first maximum rear axle braking force, which is less than the first maximum front axle braking force, can be provided using the at least one rear axle brake, and
after the specified front axle brake temperature is reached: (i) a second maximum front axle braking force can be provided using the at least one front axle brake, and (ii) a second maximum rear axle braking force can be provided using the at least one rear axle brake,
wherein the second maximum front axle braking force is less than the first maximum front axle braking force, and the second maximum rear axle braking force is greater than the first maximum rear axle braking force.

6. The vehicle according to claim 5, wherein the second maximum front axle braking force is greater than the second maximum rear axle braking force.

7. The vehicle according to claim 5, wherein the control device is configured to deactivate the at least one rear axle brake when a specified rear axle brake temperature is reached, which is higher than the specified front axle brake temperature.

8. The vehicle according to claim 7, wherein after the at least one rear axle brake has been deactivated, the second maximum front axle braking force can still be provided using the at least one front axle brake.
